(19) United States
(12) Patent Application Publication
(10) Pub. No.: US 2015/0256802 A1
(43) Pub. Date: Sep. 10, 2015

(54) PROJECTION DEVICE AND CONTROL METHOD THEREOF

(71) Applicant: LITE-ON TECHNOLOGY CORPORATION, Taipei (TW)

(72) Inventors: Ju-Hung TSOU, Taipei (TW); Shi-Jia PEI, Taipei (TW); Chang-Feng LEE, Taipei (TW)

(73) Assignee: LITE-ON TECHNOLOGY CORPORATION, Taipei (TW)

(21) Appl. No.: 14/612,766

(22) Filed: Feb. 3, 2015

(30) Foreign Application Priority Data
Mar. 6, 2014 (CN) 201410081730.9

(51) Int. Cl. H04N 9/31; G02B 26/10

(52) U.S. Cl. CPC H04N 9/3135; G02B 26/10

(57) ABSTRACT

A control method of a projection device is disclosed. The control method includes following steps: entering at least one projection mode; detecting at least one motion trace of the projection device; adjusting at least one swing angle of a scan unit of the projection device according to at least one motion trace to adjust a projection scope that the projection device projects on a projection surface.

This application claims the benefit of People's Republic of China application Serial No. 201410081730.9, filed Mar. 6, 2014, the subject matter of which is incorporated therein by reference.

### BACKGROUND OF THE INVENTION

1. Field of the Invention

The invention relates in general to a projection device and a control method thereof, and more particularly to a projection device capable of adjusting the projection range and a control method thereof.

2. Description of the Related Art

The projection device, particularly the scan type projection device using laser light source, normally does not perform focusing. The swing range of the scan unit of the scan type projection device is normally fixed, and so is the corresponding projection scope that the projection device projects on the projection surface if the projection device is placed at a fixed position. If the projection scope needs to be adjusted, the adjustment normally can be achieved by adjusting the distance between the projection device and the projection surface. In addition to the distance between the projection device and the projection surface, the projection scope is also affected by the inclination or rotation of the projection device. Therefore, how to provide a method for adjusting the projection scope to enhance the convenience of use has become a prominent task for the industries.

### SUMMARY OF THE INVENTION

The invention is directed to a projection device and a control method thereof.

According to one embodiment of the present invention, a control method of a projection device is disclosed. The control method includes following steps: entering at least one projection mode; detecting at least one motion trace of the projection device; adjusting at least one swing angle of a scan unit of the projection device according to at least one motion trace to adjust a projection scope that the projection device projects on a projection surface.

According to another embodiment of the present invention, a projection device is disclosed. The projection device includes a light source module, a motion detection module, and a controller. The light source module emits an image beam. The motion detection module detects at least one motion trace of the projection device. The controller adjusts a projection scope that the projection device projects on a projection surface according to at least one motion trace.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of a projection device according to an embodiment of the present invention.

FIG. 2 is a schematic diagram of rotation and inclination of a projection device.

FIG. 3 is a flowchart of a control method of a projection device according to an embodiment of the present invention.

FIG. 4 is a schematic diagram of a projection device at an initial position.

FIG. 5 is a schematic diagram of the inclined projection device of FIG. 4.

FIG. 6 is a schematic diagram before and after a projection device is displaced.

### DETAILED DESCRIPTION OF THE INVENTION

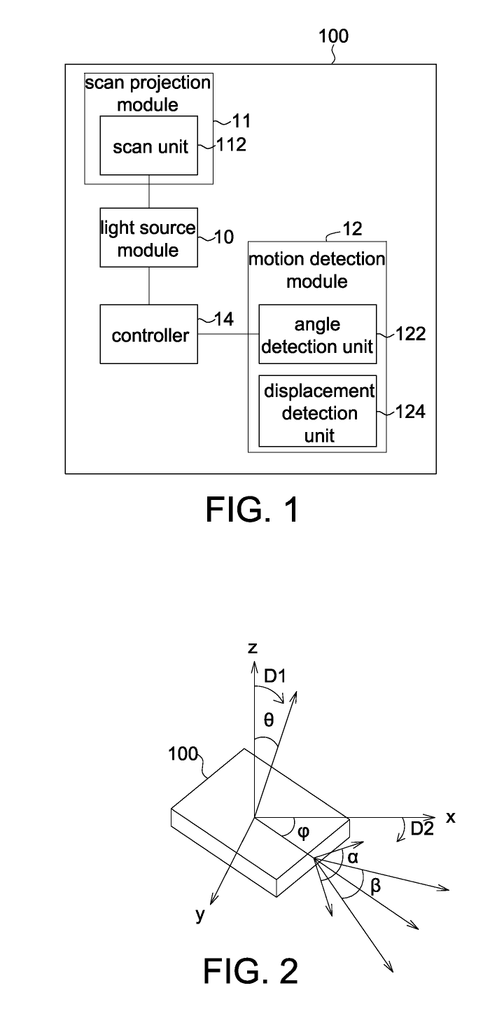

FIG. 1 is a block diagram of a projection device according to an embodiment of the present invention. The projection device 100 includes a light source module 10, a scan projection module 11, a motion detection module 12 and a controller 14. The light source module 10 emits an image beam to the scan projection module 11. The scan projection module 11 scans and projects the image beam onto a projection surface. The motion detection module 12 detects a motion trace of the projection device 100. The controller 14 adjusts a swinging range of the scan projection module 11 and, therefore, adjusts a projection scope that the projection device 100 projects on the projection surface according to the motion trace. In the present embodiment, the motion trace detected by the motion detection module 12 includes a motion direction and a motion magnitude. The motion magnitude can be defined as a rotation angle or a displacement according to the motion state (rotation or displacement) of the projection device.

In the present embodiment, the scan projection module 11 includes a scan unit 112. The scan unit 112 can swing in a first direction and swing in a second direction to drive the image beam to scan back and forth on the projection surface to generate a projection image. The scan unit 112 can be realized by a dual-axis scanning mirror or two single-axis scanning mirrors. The scan unit 112 can be realized by a micro-electro-mechanical system (MEMS) scanning mirror. In the present embodiment, the scan unit 112 swings in the first direction at a first swing angle and swings in the second direction at a second swing angle. The projection scope of the projection device 100 on the projection surface is associated with to the first swing angle and the second swing angle.

FIG. 2 is a schematic diagram of rotation and inclination of a projection device. In the present embodiment, the motion detection module 12 includes an angle detection unit 122, such as a gyroscope. The motion detection module 12 detects a first motion trace of the projection device 100. The first motion trace includes a first direction and a first rotation angle. The first direction is such as direction D1, and the first rotation angle is such as angle θ. The motion detection module 12 further detects a second motion trace of the projection device 100. In other words, the angle detection unit 122 detects the first rotation angle θ of the projection device 100 in the first direction D1 as well as a second rotation angle φ of the projection device 100 in a second direction D2. Refer to FIG. 2. Suppose the x-axis direction of FIG. 2 is perpendicular to the projection surface which is parallel to the yz plane, then the rotation of the projection device 100 in the space can be defined as the first rotation angle θ and the second rotation angle φ, wherein the first rotation angle θ is the angle that the projection device 100 rotates about the y-axis, and the second rotation angle φ is the angle that the projection device 100 rotates about the z-axis. In the present embodiment, the rotation of the projection device 100 in the first direction D1 and that in the second direction D2 are associated with the swing of the scan unit 112 in the first direction and that in the second direction respectively.

The controller 14 adjusts the first swing angle α at which the scan unit 112 swings about the y-axis in the first direction according to the first rotation angle θ in the first direction D1 so as to adjust the first boundary position of the projection scope on the projection surface corresponding to the first direction D1. The first boundary position of the projection scope corresponding to the first direction D1 is, for example, at least one of a top boundary position and a bottom boundary position of the projection scope on the projection surface. The first swing angle α is, for example, coplanar with the first rotation angle θ. The controller 14 further adjusts the second swing angle β at which the scan unit 112 swings about the z-axis in the second direction according to the second rotation angle φ in the second direction D2 so as to adjust the second boundary position of the projection scope on the projection surface corresponding to the second direction D2. The second direction D2 is different from the first direction D1. The second boundary position of the projection scope corresponding to the second direction D2 is, for example, at least one of a right boundary position and a left boundary position of the projection scope on the projection surface. The second swing angle β, for example, coplanar with the second rotation angle φ.

In the present embodiment, the motion detection module 12 further includes a displacement detection unit 124 to detect a third motion trace of the projection device 100. The third motion trace includes a third direction and a displacement. In other words, the displacement detection unit 124 detects a displacement of the projection device 100 in a third direction. Preferably, the third direction is perpendicular to the projection surface. The controller 14 further adjusts the first swing angle α and/or the second swing angle β at which the scan unit 112 swings in the first direction and/or the second direction according to the displacement in the third direction so as to adjust the projection scope of the projection device on the projection surface. For example, the controller 14 reduces or increases the swinging range of the scan unit 112 as the projection device 100 moves away from or gets close to the projection surface so as to adjust the projection scope on the projection surface to be fixed.

In the present embodiment, the motion detection module 12 detects at least one motion trace of the projection device 100, and the controller 14 adjusts at least one swing angle of the scan unit 112 according to the detected one or more motion traces so as to adjust the projection scope on the projection surface. In the present embodiment, the controller 14 adjusts the swinging range to project a fixed projection scope and/or a controllable projection scope on the projection surface according to the detected motion trace(s). Adjusting the swinging range to project the fixed projection scope means the controller 14 reverses the changed projection scope caused by the rotation or displacement of the projection device 100 to the original projection scope, such that the projection scope on the projection surface remains fixed. Adjusting the swinging range to project the controllable projection scope means the controller 14 regards the motion trace of the rotation or displacement of the projection device 100 as a control command for controlling the projection scope on the projection surface, and adjusts the swinging range to control the projection scope.

In the present embodiment, the controller 14 selectively adjusts the swinging range to project a fixed projection scope or a controllable projection scope according to the projection mode. In the present embodiment, the projection mode comprises a fixed mode and a control mode. In the fixed mode, the swinging range is adjusted to project the fixed projection scope. In the control mode, the swinging range is adjusted to the controllable projection scope.

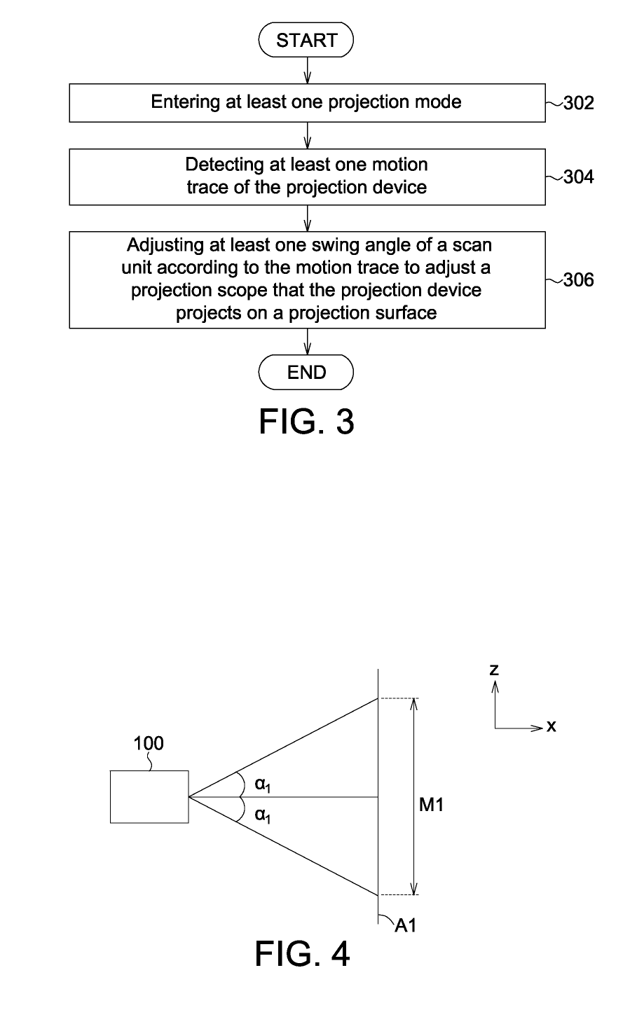

The present invention further discloses a control method of a projection device. FIG. 3 is a flowchart of a control method of a projection device according to an embodiment of the present invention. Firstly, the method begins at step 302, the projection device 110 enters at least one projection mode. Next, the method proceeds to step 304, the motion detection module 12 detects at least one motion trace of the projection device 110. Then, the method proceeds to step 306, the controller 14 adjusts at least one swing angle of the scan unit 112 according to the motion trace to adjust the projection scope that the projection device 110 projects on a projection surface. The projection mode comprises a control mode and a fixed mode. If the projection device 110 enters a control mode in step 302, then the controller 14 adjusts at least one swing angle of the scan unit 112 according to the motion trace to make the size of the projection scope of the projection device 110 on the projection surface to be changed in step 306. If the projection device 110 enters a fixed mode in step 302, then the controller 14 adjusts at least one swing angle of the scan unit 112 according to the motion trace to make the size of the projection scope of the projection device 110 on the projection surface to be fixed in step 306.

For example, suppose the projection device 110 enters the control mode in step 302. In an embodiment, if the motion trace of the projection device 110 detected by the motion detection module 12 is a first motion magnitude of an upward motion, then the controller 14 increases the swing angle at which the scan unit 112 swings up and down to increase the distance between the top boundary and the bottom boundary of the projection scope on the projection surface. In contrast, if the motion trace of the projection device 110 detected by the motion detection module 12 is a first motion magnitude of a downward motion, then the controller 14 reduces the swing angle at which the scan unit 112 swings up and down to reduce the distance between the top boundary and the bottom boundary of the projection scope on the projection surface. Similarly, the motion detection module 12 may also detect the motion trace of the projection device 110 in another direction to adjust the boundary of the projection scope in another direction. If the motion trace of the projection device 110 detected by the motion detection module 12 is a second motion magnitude of a rightward motion, then the controller 14 increases the swing angle at which the scan unit 112 swings left and right to increase the distance between the left boundary and the right boundary of the projection scope on the projection surface. In contrast, if the motion trace of the projection device 110 detected by the motion detection module 12 is a second motion magnitude of a leftward motion, then the controller 14 reduces the swing angle at which the scan unit 112 swings left and right to reduce the distance between the left boundary and the right boundary of the projection scope on the projection surface.

The above embodiments are exemplary and explanatory only. The present invention does not specify that the controller has to correspondingly adjust the swing direction of the scan unit according to the motion direction of the motion trace. One skilled in the art may modify the control method according to practical use. In another example, the motion detection module 12 can only detect the motion magnitude of an upward or a downward motion of the projection device 110 and make the controller 14 increase or reduce both of the swing angle at which the scan unit 112 swings up and down and the swing angle at which the scan unit 112 swings left and right to increase or reduce the distance between the top boundary and the bottom boundary of the projection scope and the distance between the left boundary and the right boundary of the projection scope, such that the projection scope on the projection surface is enlarged or narrowed.

In the present embodiment, the controller 14 can further determines the adjustment amount of increasing or reducing the corresponding swing angle of the scan unit 112 according to the motion magnitude of the detected motion trace(s).

On the other hand, suppose the projection device 110 enters the fixed mode in step 302. Then, in step 306, the controller 14 adjusts at least one swing angle of the scan unit 112 according to the detected motion trace(s), and reverses the changed projection scope of the projection range caused by the rotation or displacement of the projection device 100 to the original projection scope, such that the projection scope on the projection surface remains fixed. Details of the method for reversing the changed projection scope caused by the rotation or displacement of the projection device 100 to the original projection scope are disclosed below with exemplifications.

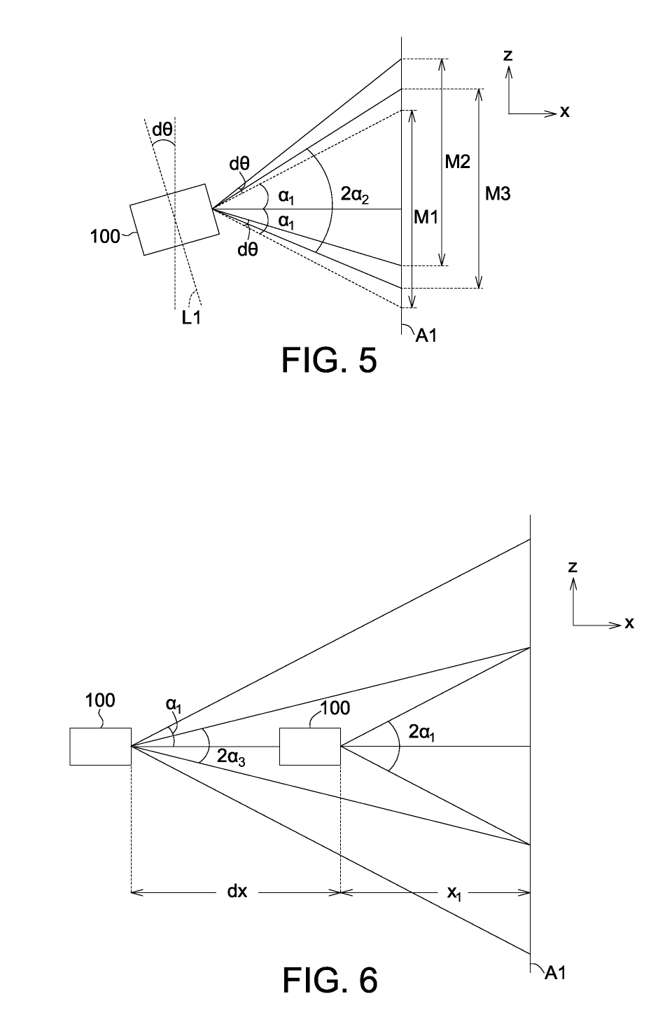

Please refer to both FIG. 4 and FIG. 5. FIG. 4 is a schematic diagram of a projection device at an initial position. FIG. 5 is a schematic diagram of the inclined projection device of FIG. 4. Suppose the projection device 110 enters the fixed mode, and the scan unit 112 of FIG. 4 swings up and down at a swing angle 2α₁ and forms a projection scope M1 on a projection surface A1 at the initial position. FIG. 5 illustrates the situation when the projection device 100 of FIG. 4 is rotated upward for an angle dθ.

Meanwhile, the top surface of the projection device 100 and the xy plane forms an angle dθ, i.e. the angle dθ between the axial line L1 of the projection device 100 and the z-axis, such that the projection scope on the projection surface A1 will be enlarged to a projection scope M2. After the first rotation angle dθ of an upward motion was detected by the angle detection unit 122, the controller 14 reduces the first swing angle at which the scan unit 112 swings up and down to an angle 2α₂ according to the first rotation angle dθ so as to reduce the distance between the top boundary and the bottom boundary of the projection scope to form a projection scope M3, such that the projection scope on the projection surface A1 remains fixed. That is, the projection range M1 is equivalent to the projection range M3. Similarly, after the second rotation angle of a rightward motion was detected by the angle detection unit 122, the controller 14 reduces the second swing angle at which the scan unit 112 swings left and right according to the second rotation angle so as to reduce the distance between the left boundary and the right boundary of the projection scope, such that the projection scope on the projection surface A1 remains fixed. Similarly, the controller 14 may also adjust the swing angle at which the scan unit 112 swings in a corresponding direction according to the detected downward or leftward motion, and the detailed descriptions thereof will be omitted herein.

Another exemplification is disclosed below. FIG. 6 is a schematic diagram before and after the projection device 100 is displaced. Suppose the scan unit 112 of the projection device 100 of FIG. 6 swings up and down at a swing angle of 2α₁, and the distance between the projection device 100 and the projection surface A1 is x₁. As shown in FIG. 6, after the projection device 100 was displaced for a distance dx, the distance between the projection device 100 and the projection surface A1 becomes x1+dx, and the projection scope on the projection surface A1 will be enlarged. After the motion detection unit 124 detected that the projection device 100 was displaced for a displacement dx in the third direction (such as in the x-axis direction), the controller 14 adjusts the first swing angle at which the scan unit 112 swings up and down to an angle 2α₃, and the second swing angle at which the scan unit 112 swings left and right according to the displacement dx in the third direction so as to reduce the distance between the top boundary and the bottom boundary and the distance between the left boundary and the right boundary of the projection range, such that the projection scope on the projection surface after the projection device 100 was displaced is equivalent to the original projection scope, and therefore the projection scope on the projection surface remains fixed. The above embodiments are exemplary and explanatory only, not for limiting the scope of the present invention. For example, in the embodiments of the present invention, the swinging range of the scan unit 112 can be adjusted to enlarge or narrow the projection scope according to the first rotation angle, the second rotation angle and the displacement in the third direction.

According to a projection device and control method thereof disclosed in above embodiments of the present invention, the projection scope is adjusted according to the detected first and second rotation angles of the projection device. In an embodiment, the projection scope can be enlarged or narrowed. In another embodiment, the projection scope can be adjusted according to the displacement in the third direction. Furthermore, in yet another embodiment, the projection scope can be adjusted according to the first rotation angle, the second rotation angle and the displacement in the third direction. In some embodiments, it is very convenient that the user can adjust the size or boundary of the projection scope simply by rotating or waving the projection device. In some other embodiments, even if the projection device is displaced or rotated, the original projection scope still can be maintained, and such design is particularly suitable for applications when a fixed projection scope on the projection surface is desired by the user.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A control method of a projection device, comprising:
entering at least one projection mode;
detecting at least one motion trace of the projection device;
adjusting at least one swing angle of a scan unit of the projection device according to the at least one motion trace to adjust a projection scope that the projection device projects on a projection surface.

2. The control method of a projection device according to claim 1, wherein the at least one projection mode comprises a control mode and a fixed mode, wherein the at least one swing angle of the scan unit is adjusted according to the at least one motion trace to make a size of the projection scope on the projection surface to be changed in the control mode, and the at least one swing angle of the scan unit is adjusted according to the at least one motion trace to make the size of the projection scope on the projection surface to be fixed in the fixed mode.

3. The control method of a projection device according to claim 1, wherein the motion trace has a motion direction and a motion magnitude;
wherein the step of adjusting the projection scope comprises:
adjusting the swing angle of the scan unit according to the motion direction and the motion magnitude to adjust at least one boundary position of the projection scope.

4. The control method of a projection device according to claim 1,
wherein the at least one motion trace comprises a first motion trace at least comprising a first direction and a first rotation angle;
wherein the step of adjusting the projection scope comprises:
adjusting a first swing angle of the scan unit according to the first direction and the first rotation angle to adjust at least one of a top boundary position and a bottom boundary position of the projection scope.

5. The control method of a projection device according to claim 1, wherein the at least one motion trace comprises a second motion trace comprising a second direction and a second rotation angle;
wherein the step of adjusting the projection scope comprises:
adjusting a second swing angle of the scan unit according to the second direction and the second rotation angle to adjust at least one of a right boundary position and a left boundary position of the projection scope.

6. The control method of a projection device according to claim 1, wherein the at least one motion trace comprises a third motion trace comprising a third direction and a displacement;
wherein the step of adjusting the projection scope comprises:
adjusting at least one of a first swing angle and a second swing angle of the scan unit according to the third direction and the displacement to adjust at least one of a top boundary position, a bottom boundary position, a right boundary position and a left boundary position of the projection scope.

7. The control method of a projection device according to claim 1, wherein the at least one projection mode comprises a control mode, and in the step of adjusting the projection scope, a size of the projection scope on the projection surface is controllable when the projection device is in the control mode.

8. The control method of a projection device according to claim 1, wherein the at least one projection mode comprises a fixed mode, and in the step of adjusting the projection scope, a size of the projection scope on the projection surface is adjusted to be fixed when the projection device is in the fixed mode.

9. A projection device, comprising:
a light source module for emitting an image beam;
a scan projection module for scanning and projecting the image beam onto a projection surface;
a motion detection module for detecting at least one motion trace of the projection device; and
a controller for adjusting a projection scope that the projection device projects on the projection surface according to the at least one motion trace.

10. The projection device according to claim 9, wherein the scan projection module comprises:
a scan unit;
wherein the motion trace has a motion direction and a motion magnitude; and
wherein the controller adjusts at least one swing angle of the scan unit according to the motion direction and the motion magnitude for adjusting the projection scope.

11. The projection device according to claim 9, wherein the motion detection module comprises an angle detection unit and a displacement detection unit.

12. The projection device according to claim 11, wherein the scan projection module comprises:
a scan unit;
wherein the angle detection unit detects a first motion trace comprising a first direction and a first rotation angle; and
wherein the controller adjusts a first swing angle of the scan unit according to the first direction and the first rotation angle to adjust at least one of a top boundary position and a bottom boundary position of the projection scope.

13. The projection device according to claim 11, wherein the scan projection module comprises:
a scan unit;
wherein the angle detection unit detects a second motion trace having a second direction and a second rotation angle; and
wherein the controller adjusts a second swing angle of the scan unit according to the second direction and the second rotation angle to adjust at least one of a right boundary position and a left boundary position of the projection scope.

14. The projection device according to claim 11, wherein the scan projection module comprises:
a scan unit;
wherein the displacement detection unit detects a third motion trace having a third direction and a displacement; and
wherein the controller adjusts a first swing angle or a second swing angle of the scan unit according to the third direction and the displacement to adjust at least one of a top boundary position, a bottom boundary position, a right boundary position and a left boundary position of the projection scope.

15. The projection device according to claim 9, wherein the projection device has a control mode, and the controller adjusts the projection scope on the projection surface to a different size when the projection device is in the control mode.

16. The projection device according to claim 9, wherein the projection device has a fixed mode, and the controller adjusts the projection scope on the projection surface to a fixed size when the projection device is in the fixed mode.

17. A control method of a projection device, comprising:
projecting a projection scope on a projection surface by swinging a scan unit at a first swinging range;
detecting at least one motion trace of the projection device;
adjusting the first swinging range of the scan unit to a second swinging range according to the at least one motion trace to adjust the projection scope on the projection surface.

18. The control method of a projection device according to claim 17, wherein at least one of a top boundary position, a bottom boundary position, a right boundary position and a left boundary position of the projection scope on the projection surface is adjusted.

19. The control method of a projection device according to claim 17, further comprising:
entering at least one projection mode, wherein the at least one projection mode comprises a control mode and a fixed mode,
wherein a size of the projection scope on the projection surface is adjusted to be changed in the control mode, and the size of the projection scope on the projection surface is adjusted to be fixed in the fixed mode.
